(19) United States
(12) Patent Application Publication
(10) Pub. No.: US 2021/0398093 A1
(43) Pub. Date: Dec. 23, 2021

(54) METHOD AND SYSTEM FOR PAYMENT INTEGRATION WITH PROVENANCE SUPPLY CHAIN EVENTS

(71) Applicant: MASTERCARD INTERNATIONAL INCORPORATED, Purchase, NY (US)

(72) Inventors: Susan Lynch, Cavan (IE); Leandro Nunes Da Silva Carvalho, Metuchen, NJ (US); Bella Wu, Roslyn, NY (US); Paul Taylor, Dundrum (IE); Robert Collins, Blackrock (IE); Deborah Eleanor Barta, New York, NY (US)

(73) Assignee: MASTERCARD INTERNATIONAL INCORPORATED, Purchase, NY (US)

(21) Appl. No.: 16/946,397

(22) Filed: Jun. 19, 2020

(51) Int. Cl. G06Q 20/10; G06Q 20/38; G06Q 20/40; G06Q 40/02; G06Q 20/34; H04L 9/32; G06F 16/23; G06F 9/54; H04L 29/08

(52) U.S. Cl. CPC G06Q 20/108; G06Q 20/3827; G06Q 20/405; G06Q 40/02; G06Q 20/34; G06Q 50/28; H04L 9/3236; G06F 16/2379; G06F 9/542; H04L 67/26; G06Q 2220/00; G06Q 20/4014

(57) ABSTRACT

A method for triggering payment transactions through predetermined events identified using a blockchain includes: receiving, at a first system, trigger data including a first account identifier, second account identifier, and trigger event values; receiving, at the first system, blockchain data values, each including a hash value; identifying, by the first system, a match between a specific blockchain data value and a specific trigger event value based on the hash value; transmitting, by the first system, a notification message to a second system including the first account identifier and second account identifier; identifying, by the second system, a first payment identifier using the first account identifier and a second payment identifier using the second account identifier; and initiating, by the second system, a payment transaction for payment from a transaction account associated with the first payment identifier to a transaction account associated with the second payment identifier.

### FIELD

The present disclosure relates to payment integration with events in a provenance supply chain implementing through a blockchain, specifically the use of triggers that result in automated payment transactions when predetermined events occur as added to the supply chain blockchain.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

Because blockchains store an immutable record for any manner of data, some blockchains have been developed to store information regarding the provenance of items, such as tracking the production and distribution of perishable goods or high value items. For example, a blockchain may be used to track produce, where an entry may be created when the produce is harvested, picked up from the harvesting location, dropped off at a distributor, loaded into a truck by the distributor, arrived at a retailer, accepted by the retailer, and sold to a consumer. By storing entries related to these actions on the blockchain, a consumer or other interested party can quickly see an immutable record of the life of the produce, such as to ensure its age and freshness, or to check to see if the produce is sourced from a sustainable farm. Additionally, if produce needs to be recalled, an immutable record of all produce may make it easier to track where recallable items are located.

However, entities involved in such a supply chain may be required to perform additional actions than they are used to in order to ensure that the supply chain is kept up to date and the records accurate. For example, a buyer may have to, on top of standard purchase order processing, product procurement, inventory, and payments, ensure that they update the supply chain when goods are received and when those received goods are sold further down the line. Thus, there is a need for a system that can add efficiency into such supply chains to reduce the interactions necessary by involved entities.

### SUMMARY

The present disclosure provides a description of systems and methods for triggering payment transactions through predetermined events identified using a blockchain. Entities involved in the supply chain can register their transaction account with a payment provider for facilitating payments necessary during operation of the supply chain. When two entities have an agreement involving products tracked via the supply chain blockchain, they can register trigger events with the blockchain. When a trigger event occurs, such as when a product is delivered to the buyer from the supplier, the trigger event may execute, which may result in the payment provider automatically initiating payment from the buyer to the supplier using the registered account information. In another example, an executed contract being uploaded to the supply chain blockchain may be another trigger event that results in an automatic payment from one party to another. As a result, involved entities can focus on keeping the provenance blockchain up to date, knowing that all required payments will be automatically handled by the payment processor on their behalf.

A method for triggering payment transactions through predetermined events identified using a blockchain includes: receiving, at a first computing system, trigger data from an external computing device, the trigger data including at least a first account identifier, a second account identifier, and one or more trigger event values; receiving, at the first computing system, one or more blockchain data values stored in a block in a blockchain, wherein each blockchain data value includes at least a hash value; identifying, by the first computing system, a match between a specific blockchain data value of the one or more blockchain data values and a specific trigger event value of the one or more trigger event values based on at least the hash value included in the specific blockchain data value and the specific trigger event value; electronically transmitting, by the first computing system, a notification message to a second computing system, the notification message including at least the first account identifier and the second account identifier; identifying, by the second computing system, a first payment identifier based on the received first account identifier and a second payment identifier based on the received second account identifier; and initiating, by the second computing system, a payment transaction for payment from a transaction account associated with the first payment identifier to a transaction account associated with the second payment identifier for a predetermined transaction amount.

A system for triggering payment transactions through predetermined events identified using a blockchain includes: a first computing system; a second computing system; and an external computing device, wherein the first computing system receives trigger data from the external computing device, the trigger data including at least a first account identifier, a second account identifier, and one or more trigger event values, receives one or more blockchain data values stored in a block in a blockchain, wherein each blockchain data value includes at least a hash value, identifies a match between a specific blockchain data value of the one or more blockchain data values and a specific trigger event value of the one or more trigger event values based on at least the hash value included in the specific blockchain data value and the specific trigger event value, and electronically transmits a notification message to the second computing system, the notification message including at least the first account identifier and the second account identifier, the second computing system receives the notification message from the first computing system, identifies a first payment identifier based on the received first account identifier and a second payment identifier based on the received second account identifier, and initiates a payment transaction for payment from a transaction account associated with the first payment identifier to a transaction account associated with the second payment identifier for a predetermined transaction amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for trigger payment transactions through predetermined events in a blockchain in accordance with exemplary embodiments.

FIG. 2 is a block diagram illustrating a computing system of the system of FIG. 1 for triggering payment transactions and identifying and executing trigger events in accordance with exemplary embodiments.

FIG. 3 is a flow diagram illustrating a process for initiating an automatic payment transaction based on an event identified in a provenance blockchain in accordance with exemplary embodiments.

FIG. 4 is a flow chart illustrating an exemplary method for triggering payment transactions through predetermined events identified using a blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

System for Payment Integration with a Provenance Blockchain

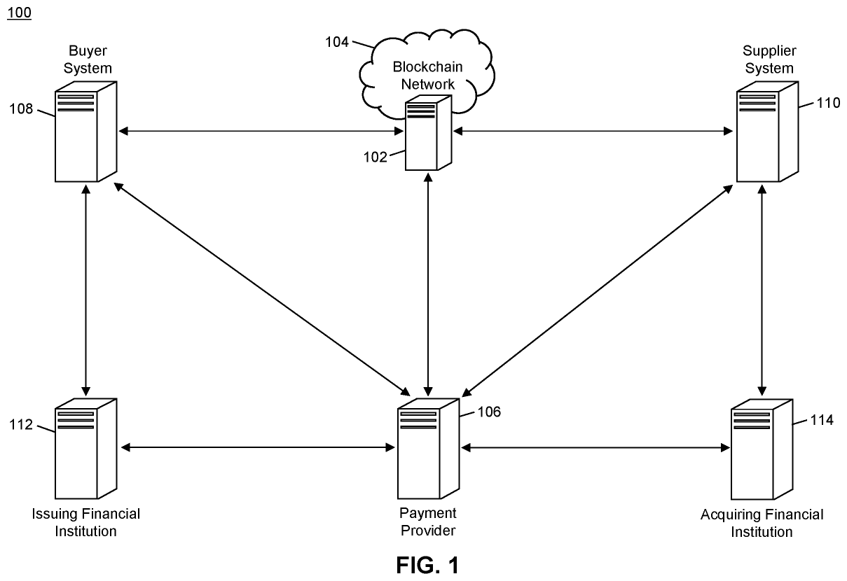

FIG. 1 illustrates a system 100 for integrating automated payment transactions with a provenance blockchain that are initiated upon the occurrence of trigger events on the blockchain.

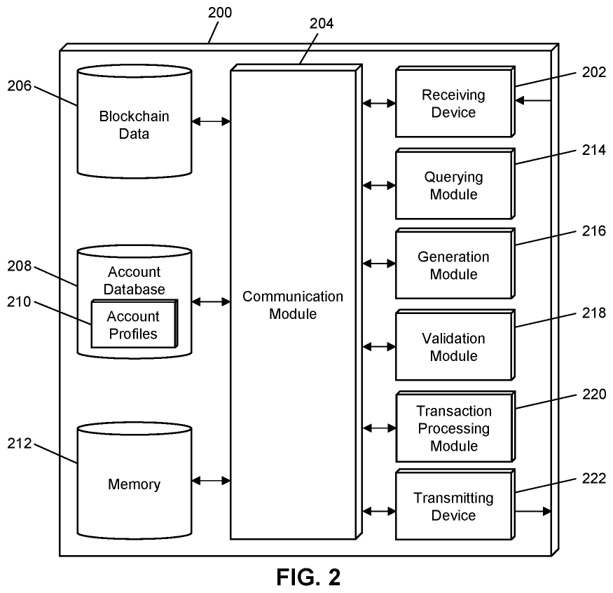

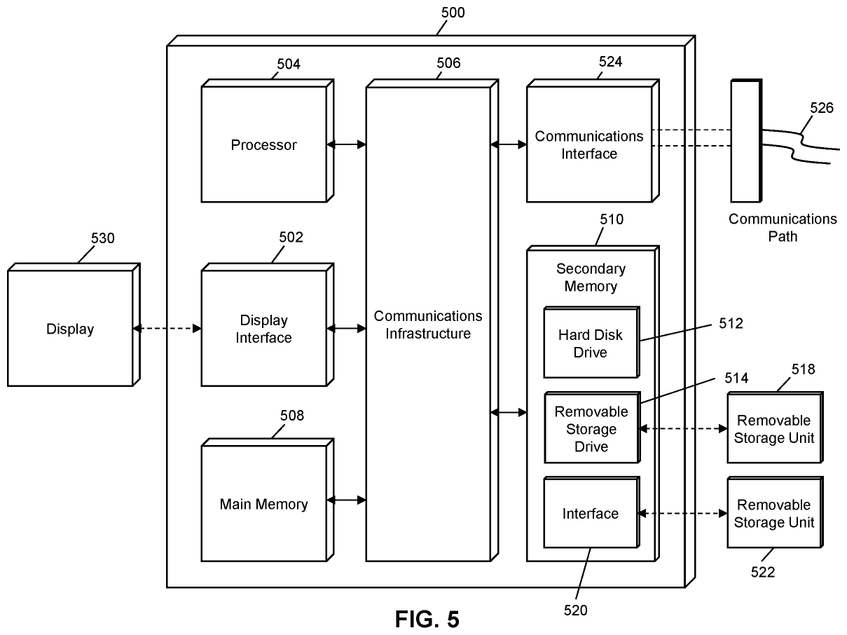

The system 100 may include one or more blockchain nodes 102. Each blockchain node 102 may be part of a blockchain network 104. Each blockchain node 102 may be a computing system, such as illustrated in FIGS. 2 and 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device that stores the private key for use thereof in blockchain transactions. For instance, each computing device may each have their own private key for respective cryptographic key pairs and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of currency (e.g., a buyer system 108) that is generated using the sender's private key, a blockchain address of the recipient of currency (e.g., a supplier system 110) generated using the recipient's public key, and a blockchain currency amount that is transferred or other data being stored. In the case of the blockchain being used for data storage separate from currency, the currency amount may be replaced by such other data, as discussed below with respect to the chama. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 102 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 104 before being added to the blockchain and distributed to all of the blockchain nodes 102 in the blockchain network 104 in traditional blockchain implementations. In cases where a blockchain data value may not be related to a blockchain transaction, but instead the storage of other types of data, blockchain data values may still include or otherwise involve the validation of a digital signature.

In the system 100, the blockchain network 104 may operate and store a provenance blockchain. A provenance blockchain may be a blockchain that stores data regarding a supply chain, where events in the supply chain are stored therein. Such events may include, for instance, product manufacture, pickup by a distribution entity, transportation from one storage facility to another, delivery to a retailer, sale by the retailer, resale by a consumer, addition of a product to a grouping of products, separation of a product from a grouping of products, chargeback of a product, etc. In some cases, a blockchain data value stored in the provenance blockchain for such an event may include detailed information about the event. In other cases, the blockchain data value may include a hash value of detailed information about the event, where the detailed information may be stored in a separate data storage. In some instances, documents and other data may be stored in the blockchain data values, such as directly or via hash values that can be used to verify the underlying data (e.g., an executed contract) that may be stored elsewhere, such as possessed by the entities involved in the executed contract. Additional information regarding the use and operation of provenance blockchains can be found in U.S. patent application Ser. No. 16/875,154, entitled “Method and System for Generalized Provenance Solution for Blockchain Supply Chain Applications,” by Steven C. Davis et al., filed May 15, 2020, which is herein incorporated by reference in its entirety.

The system 100 may be configured to integrate automated payment transactions with a provenance blockchain. Automated payment transactions may be initiated by a payment provider 106. The payment provider 106 may utilize a computing system separate from the blockchain nodes 102 in the blockchain network 104, which may be any suitable configured computing system, such as illustrated in FIG. 2 or 5, discussed in more detail below. The payment provider 106 may communicate with one or more blockchain nodes 102 in the blockchain network 104 using one or more application programming interfaces (APIs) or any other suitable communication networks and methods.

In the system 100, entities involved in the provenance blockchain may register with the payment provider 106. For example, the system 100 may include a buyer system 108 and a supplier system 110 as illustrated in FIG. 1, which may correspond to computing systems of a buyer entity and a supplier entity that may do business that is tracked using the provenance blockchain. For instance, the supplier may be a product manufacturer and the buyer may be a wholesaler, the supplier may be a wholesaler and the buyer a retailer, etc. Each entity involved in the provenance blockchain that has a desire to use integrated payment transactions may register a transaction account with the payment provider 106. In some cases, the entities may register directly with the payment provider 106. In other cases, registration may be handled by one or more intermediate entities. For example, the buyer system 108 may register a transaction account to use in making payments as part of the supply chain where the buyer system 108 itself may electronically transmit their transaction account information to the payment provider 106, such as through an API or a web form, or an issuing financial institution 112 that issued the transaction account to the buyer system 108 may register the transaction account with the payment provider 106 on behalf of the buyer system 108 using any suitable method.

Registration of a transaction account with the payment provider 106 may include providing any transaction account data necessary for use of the transaction account (e.g., payment account number, name, security values, zip code or postal code, authentication information, etc.) as well as an identifier associated with the entity for use in the provenance blockchain, and any other data. For instance, a buyer system 108 or supplier system 110 may provide multiple transaction accounts and preferences for use of each one, additional payment requests, preferred currencies, information regarding associated financial institutions (e.g., issuing financial institution 112 and acquiring financial institution 114, respectively), etc. The payment provider 106 may receive the account information and store the information in a profile generated for each registered entity.

When the buyer system 108 and supplier system 110 (e.g., or any other entities involved in the provenance blockchain) agree on events that may occur on the provenance blockchain that should result in payment between the two entities, the entities may register one or more event triggers with the blockchain node 102 or another computing system (e.g., that may be separate from the blockchain node 102 or integrated in a blockchain node 102, such as through a virtual machine or other mechanism) that are to initiate an automated payment transaction. For instance, if the buyer is a retailer and the supplier is a product manufacture, the buyer and supplier may agree on a first payment each time a purchase order is submitted by the buyer to the supplier and a second payment each time delivery of products is confirmed to be made to the buyer. Trigger events may be registered by both entities (e.g., where each must confirm the trigger events), one of the involved entities (e.g., where the other entity may be required to confirm the trigger events, such as through a separate message or having digitally signed the submission), or a separate entity on behalf of one or both of the involved entities. In some cases, a trigger event may involve any number of entities that may be greater than two.

A trigger event submission may include at least an identifier of the buyer, an identifier of the supplier, and one or more trigger data values. Each trigger data value may be comprised of or include data that can be identified in blockchain data values stored in the provenance blockchain and may vary based on the type of event that is to prompt the trigger. For instance, in the above example, addition of a purchase order (e.g., the hash value of a signed or executed document submitted by the buyer) may be a trigger data value for the first trigger event, and delivery of the products (e.g., a blockchain data value with the buyer as a destination entity and one or more identifiers for products) may be a trigger data value for the second trigger event. In some cases, the trigger data value may be a hash value of the blockchain data value. The trigger data included in a trigger event submission may also include any additional data that may be based on the agreement between entities or transactions to be made. For instance, the trigger data may include an overall order number, individual numbers for each trigger data value, a transaction amount to be paid in each transaction, a separate transaction amount for each trigger data value, a desired currency type, timing information (e.g., a time or date when an automated payment is to be made), etc. In some cases, a trigger event may occur only once. In other cases, a trigger event may be recurring, such as for an ongoing purchase and delivery deal between two entities, where the event may repeat on the blockchain as part of the ongoing deal, and where the trigger event may be triggered each time the appropriate event is detected in the blockchain.

In cases where trigger event submissions may be submitted via an API utilized by the blockchain nodes 102, the trigger event submission may include data in the following format, as an example:

```
{“orderId”: “R123123131”,
  “paymentTriggers”: [
  {
```

“amountMinurUnits”: 600000,
“currencyCode”: “EUR”,
“merchantID”: “47b794f6-1891-498f-8534-9c8d340c611c”,
“buyerId”: “8c26718a-93bf-4d44-a879-18ba9a3250e3”,
“customerOrderReference”: “SC-01234567”,
“authEvent”: {

“eventType”: “LIFECYCLEENTRY”,
“eventHash”:

“cBc72j5/hr5FeothnqbN7cBHz1mX8xAjati7ehPQ2QA=”

},
“captureEvent”: {

“eventType”: “DOCUMENTENTRY”,
“documentId”: {

“documentType”: “IMPORTDECLARATION”,
“documentId”: “AB-104-CD-9992”,
“userId”: “123131123123”

}

},
“returnEvent”: {

“eventType”: “LIFECYCLEENTRY”,
“eventHash”:

“cBc72j5/hr5Fe0thnqbN7cBHz1mX8xAjati7ehPQ2QC=”

}

```
  }
  ]
}
```

In the above example, the transaction amount may be set for all trigger events in the submission to be 600,000 euro, with the merchant identifier and buyer identifier being set and a customer order number of SC-01234567 being set for all of the events. The trigger event submission also includes three trigger data values, two for new entries of lifecycle events in the provenance blockchain (e.g., manufacturer of a product, delivery of a product, transfer of product ownership, etc.) and one for the entry of a new document in the provenance blockchain, where the document has a document identifier of AB-104-CD-9992, such as a new purchase order being submitted by the buyer.

The blockchain node 102 may receive the trigger event submission from an entity and may store the data in a data storage. When new blockchain data values are added to the blockchain, the blockchain node 102 may identify events that occur and may determine if any of the occurring events trigger a registered and active trigger event. New blockchain data values may be added using any suitable mechanism, and may be submitted by buyer systems 108, supplier systems 110, or any other entities involved in the provenance blockchain. If the event on the provenance blockchain triggers a trigger event, then the blockchain node 102 may identify the data associated with that trigger event, such as the identifiers for each of the involved entities and the transaction amount to be paid from one entity to another. The blockchain node 102 may then electronically transmit a notification message to the payment provider 106, such as through an API, where the notification message may include at least the identifier for the payer (e.g., the buyer), the identifier for the recipient (e.g., the supplier), and the transaction amount, as well as any other necessary data (e.g., a purchase order number, the hash value of the blockchain data value, etc.).

The payment provider 106 may receive the notification message and begin a process to automatically initiate a payment transaction for payment from the payer to the payee for the transaction amount. The payment provider 106 may identify transaction account information for each of the involved entities based on the received identifiers and the registration by the entities. For instance, the payment provider may use the identifier for the payer to identify the transaction account registered by the buyer system 108. Once the payment provider 106 has identified each transaction account, the payment provider 106 may initiate an electronic payment transaction for payment of the provided transaction amount from the transaction account of the payer to the transaction account of the payee.

In some embodiments, the electronic payment transaction may be conducted by electronically transmitting the transaction information and transaction amount to the issuing financial institution 112 that issued the payer's transaction account or to the acquiring financial institution 114 that issued the payee's transaction account. In other embodiments, the payment provider 106 may electronically submit a transaction message to a payment network via payment rails associated therewith. For example, the payment provider 106 may submit an authorization message to a payment processor, where the authorization messages is a specially formatted transaction message that is formatted pursuant to one or more appropriate standards, such as the International Organization of Standardization's ISO 8583 or ISO 20022 standards, where the transaction message includes the transaction account numbers for the payer transaction account and the payee transaction account, the transaction amount, and any other necessary data. The payment transaction may be then be processed using traditional methods and systems. In some embodiments, some electronic payment transactions may be blockchain transactions processed using a blockchain separate from the provenance blockchain, such as a blockchain used for the storage and transfer of digital currency.

The payment transaction may be processed, which may result in payment from the issuing financial institution 112 to the acquiring financial institution 114 and where the transaction account of the payer may be debited by the issuing financial institution 112 accordingly and the transaction account of payee credited by the acquiring financial institution 114. The payment may thus be automatically initiated and processed without directly involvement by the payer or the payee and may occur as a result of the trigger event occurring on the provenance blockchain. For instance, in the above example, the buyer system 108 may submit a signed purchase order to a blockchain node 102, which may add the signed purchase order to the provenance blockchain in a new blockchain data value in a new block, which may satisfy a trigger event resulting in payment from the buyer to the supplier based on the registered trigger data.

In some embodiments, one or more of the above actions may be implemented using smart contracts in the provenance blockchain. For example, trigger events may be stored in the provenance blockchain via smart contracts, where the smart contract may self-execute upon fulfillment of the trigger. For instance, in the above example, when a signed purchase order is submitted by the buyer system 108, a smart contract may self-execute, which may result in submission of the notification message to the payment provider 106 that includes the identifiers for the payer and payee and the transaction amount, which may thereby initiate the payment transaction from the payer to the payee by the payment provider 106. In another example, smart contracts may be used to submit new events for storage in the provenance blockchain. For instance, in the above example, a smart contract may detect when delivery of the products is made to the buyer (e.g., when a bar code or other machine readable code affixed to the shipment is scanned by the delivering entity) and may self-execute to submit a new event for the delivery to a blockchain node 102 for addition to the blockchain as a new blockchain data value. Other uses for smart contracts may include detection of submitted documents or other data, cancellation of trigger events as a result of other triggers, submission or change of transaction account information, etc.

The methods and systems discussed herein thus integrate electronic payment transactions in a provenance blockchain for a supply chain. This enables entities involved in a provenance blockchain to focus on maintaining the provenance blockchain after registering their transaction account information without the need to initiate new payment transactions or manage recurring payments. This can result in greater participation in the provenance blockchain and to reduce missed payments, which can foster stronger business relationships and ensure greater accuracy of provenance blockchains. Thus, the methods and systems discussed herein provide for a stronger, more effective system for provenance blockchains through the automated initiation of payment transactions that occur as a result of predetermined events on a provenance blockchain.

### Computing System

FIG. 2 illustrates an embodiment of a computing system 200 in the system 100. It will be apparent to persons having skill in the relevant art that the embodiment of the computing system 200 illustrated in FIG. 2 is provided as illustration only and may not be exhaustive to all possible configurations of the computing system 200 suitable for performing the functions as discussed herein. For example, the computer system 500 illustrated in FIG. 5 and discussed in more detail below may be a suitable configuration of the computing system 200. Blockchain nodes 102 and the payment provider 106 in the system 100 of FIG. 1 may be implemented as the computing system 200 (e.g., or computer system 500) and include one or more of the components as illustrated in FIG. 2 or discussed below.

The computing system 200 may include a receiving device 202. The receiving device 202 may be configured to receive data over one or more networks via one or more network protocols. In some instances, the receiving device 202 may be configured to receive data from other blockchain nodes 102, payment providers 106, buyer systems 108, supplier systems 110, issuing financial institutions 112, acquiring financial institutions 114, payment networks, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by buyer systems 108, supplier systems 110, issuing financial institutions 112, or acquiring financial institutions 114, which may be superimposed or otherwise encoded with registration data, transaction account information, trigger event submissions, new data for inclusion in blockchain data values, etc. The receiving device 202 may also be configured to receive data signals electronically transmitted by blockchain nodes 102 that may be superimposed or otherwise encoded with blockchain data values, new blocks, confirmation messages, trigger event data, notification messages, etc. The receiving device 202 may also be configured to receive data signals electronically transmitted by payment providers 106, such as may be superimposed or otherwise encoded with requests for identifiers or other data.

The computing system 200 may also include a communication module 204. The communication module 204 may be configured to transmit data between modules, engines, databases, memories, and other components of the computing system 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing system 200 and external components of the computing system 200, such as externally connected databases, display devices, input devices, etc. The computing system 200 may also include a processing device. The processing device may be configured to perform the functions of the computing system 200 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, transaction processing module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing system 200 may also include blockchain data 206, which may be stored in a memory 212 of the computing system 200 or stored in a separate area within the computing system 200 or accessible thereby. The blockchain data 206 may include a blockchain, which may be comprised of a plurality of blocks and be associated with the blockchain network 104. The blockchain data 206 may also or alternatively include any data associated with one or more blockchain wallets that may be used by the computing system 200, such as cryptographic key pairs, unspent transaction outputs, digital asset amounts, network identifiers for the blockchain network 104, smart contracts, signature generation algorithms, encryption algorithms, transaction account data, account balances, communication information for third party services, etc. The blockchain data 206 may also include data regarding trigger events, such as trigger data submissions, trigger data values, accompanying data, payer and payee identifiers, etc.

The computing system 200 may also an account database 208. The account database 208 may be configured to store one or more account profiles 210 using a suitable data storage format and schema. The account database 208 may be a relational database that utilizes structured query language for the storage, identification, modifying, updating, accessing, etc. of structured data sets stored therein. Each account profile 210 may be a structured data set configured to store data related to a registered account for an entity involved in the provenance blockchain, such as may be registered for automated payment transactions. An account profile 210 may include, for instance, an identifier, one or more sets of transaction account data (e.g., a transaction account number, financial institution identifier, authentication data, etc.), preferences, trigger event data, etc.

The computing system 200 may also include a memory 212. The memory 212 may be configured to store data for use by the computing system 200 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the computing system 200 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for blockchain nodes 102, blockchain networks 104, and payment providers 106, address generation and validation algorithms, digital signature generation and validation algorithms, hashing algorithms for generating reference values, data for the generation and execution of smart contracts, configuration data, trigger data, formatting standards, transaction processing rules, etc.

The computing system 200 may include a querying module 214. The querying module 214 may be configured to execute queries on databases to identify information. The querying module 214 may receive one or more data values or query strings and may execute a query string based thereon on an indicated database, such as the memory 212 of the computing system 200 to identify information stored therein. The querying module 214 may then output the identified information to an appropriate engine or module of the computing system 200 as necessary. The querying module 214 may, for example, execute a query on the account database 208 to identify an account profile 210 that includes an identifier included in a received notification message, such as to identify transaction account data included therein for a new payment transaction to be initiated.

The computing system 200 may also include a generation module 216. The generation module 216 may be configured to generate data for use by the computing system 200 in performing the functions discussed herein. The generation module 216 may receive instructions as input, may generate data based on the instructions, and may output the generated data to one or more modules of the computing system 200. For example, the generation module 216 may be configured to generate blockchain data values, new blocks, block headers, reference values, smart contracts, transaction messages, trigger events, etc. The generation module 216 or other processing module of the computing system 200 may be further configured to perform actions, such as via the execution of smart contracts or other actions that may be necessary to maintain trigger events or initiate electronic payment transactions.

The computing system 200 may also include a validation module 218. The validation module 218 may be configured to perform validations for the computing system 200 as part of the functions discussed herein. The validation module 218 may receive instructions as input, which may also include data to be used in performing a validation, may perform a validation as requested, and may output a result of the validation to another module or engine of the computing system 200. The validation module 218 may, for example, be configured to validate digital signatures using suitable signature generation algorithms and keys, validate transaction values, determine the satisfaction of criteria for trigger events, determine if trigger events should remain active, validate submitted transaction account data as genuine and authorized, and other data as discussed herein.

The computing system 200 may also include a transaction processing module 220. The transaction processing module 220 may be configured to perform functions for the computing system 200 for the initiation and processing of electronic payment transactions. The transaction processing module 220 may receive transaction account information and transaction amounts as input and may output transaction messages or instructions to other modules or engines of the computing system 200. The transaction processing module 220 may be configured to, for example, generate transaction messages, format transaction messages, generate new blockchain submissions, etc.

The computing system 200 may also include a transmitting device 222. The transmitting device 222 may be configured to transmit data over one or more networks via one or more network protocols. In some instances, the transmitting device 222 may be configured to transmit data to blockchain nodes 102, payment providers 106, buyer systems 108, supplier systems 100, issuing financial institutions 112, acquiring financial institutions 114, payment networks, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to blockchain nodes 102 or payment providers 106, which may be superimposed or otherwise encoded with registration data, transaction account information, trigger event submissions, new data for inclusion in blockchain data values, etc. The transmitting device 222 may also be configured to electronically transmit data signals to blockchain nodes 102 that may be superimposed or otherwise encoded with blockchain data values, new blocks, confirmation messages, trigger event data, requests for identifiers or other data, etc. The transmitting device 222 may also be configured to electronically transmit data signals to payment providers 106, such as may be superimposed or otherwise encoded with notification messages. The transmitting device 222 may be further configured to electronically transmit data signals to payment networks, issuing financial institutions 112, or acquiring financial institutions 114 that may be superimposed or otherwise encoded with transaction messages or other data related to initiated electronic payment transactions.

### Process for Integrating Payment Transactions in a Provenance Blockchain

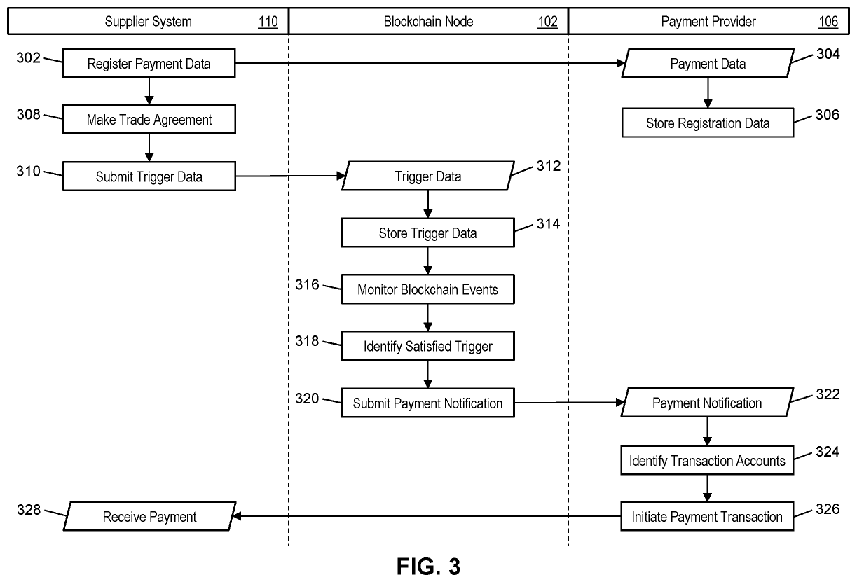

FIG. 3 illustrates a process for the integration of automated payment transactions in a provenance blockchain through the use of trigger events in the system 100 illustrated in FIG. 1 and discussed above.

In step 302, the supplier system 110 may register their transaction account information with the payment provider 106, such as by making a submission thereto using an API of the payment provider 106. In step 304, the payment provider 106 may receive the payment data, which may include at least the transaction account information (e.g., transaction account number, authentication information, acquiring financial institution 114 data, etc.) and the identifier associated with the supplier used in the provenance blockchain. In step 306, a querying module 214 of the payment provider 106 may execute a query on an account database 208 thereof for the addition of a new account profile 210 therein that includes the identifier and transaction account data included in the received payment data.

In step 308, the supplier system 110 and the buyer system 108 may make an agreement regarding payments to be made from the corresponding buyer to the corresponding supplier as a result of actions that will be tracked using the provenance blockchain. For instance, in the above example, the buyer may agree to pay a first transaction amount when a new purchase order is submitted and to also pay a second transaction amount when products are successfully delivered to the buyer. In step 310, the supplier system 110 may submit a trigger event submission to a blockchain node 102 in the blockchain network 104 using an API or other suitable method. The trigger event submission may include the identifier of the supplier, the identifier of the buyer, and one or more trigger data values. In the above example, the trigger event submission may include a trigger data value for purchase orders and a trigger data value for delivery of products to the buyer, where each trigger data value may be accompanied by the appropriate transaction amount. In step 312, a receiving device 202 of the blockchain node 102 may receive the trigger event submission.

In step 314, a querying module 214 of the blockchain node 102 may execute a query on the memory 212 of the blockchain node 102 for storage of the trigger event submission therein. In step 316, the blockchain node 102 may generate and/or confirm new blocks for the provenance blockchain using traditional methods and systems, and, for each new block, may monitor for the occurrence of new events in the provenance blockchain that may serve as trigger events. In step 318, a validation module 218 of the blockchain node 102 may determine that a trigger event has been satisfied as a result of a new event occurring on the provenance blockchain. For instance, a new blockchain data value included in a new block added to the blockchain may include data indicating delivery of products to the buyer, which may satisfy the second trigger event discussed above. In step 320, a transmitting device 222 of the blockchain node 102 may electronically transmit a notification message to the payment provider 106 using an API or other suitable communication method. The notification message may include at least the buyer identifier, supplier identifier, and transaction amount included in the trigger event submission for the satisfied trigger event. In step 322, a receiving device 202 of the payment provider 106 may receive the notification message.

In step 324, the querying module 214 of the payment provider 106 may execute one or more queries on the account database 208 thereof to identify a first account profile 210 that includes the buyer identifier from the notification message and a second account profile 210 that includes the supplier identifier from the notification message. In step 326, a generation module 216 or transaction processing module 220 of the payment provider 106 may generate a transaction message for a new electronic payment transaction for payment from the transaction account of the buyer (e.g., as identified in the first identified account profile 210) to the transaction account of the supplier (e.g., as identified in the second identified account profile 210) of the transaction amount included in the notification message. The generated transaction message may be submitted, by a transmitting device 222 of the payment provider 106, to a payment network using payment rails associated therewith, which may result in the processing of the electronic payment transaction. As a result of the processing, in step 328, the supplier may receive the payment from the buyer, which may occur as a result of the delivery of the products being added to the provenance blockchain.

### Exemplary Method for Triggering Payment Transactions

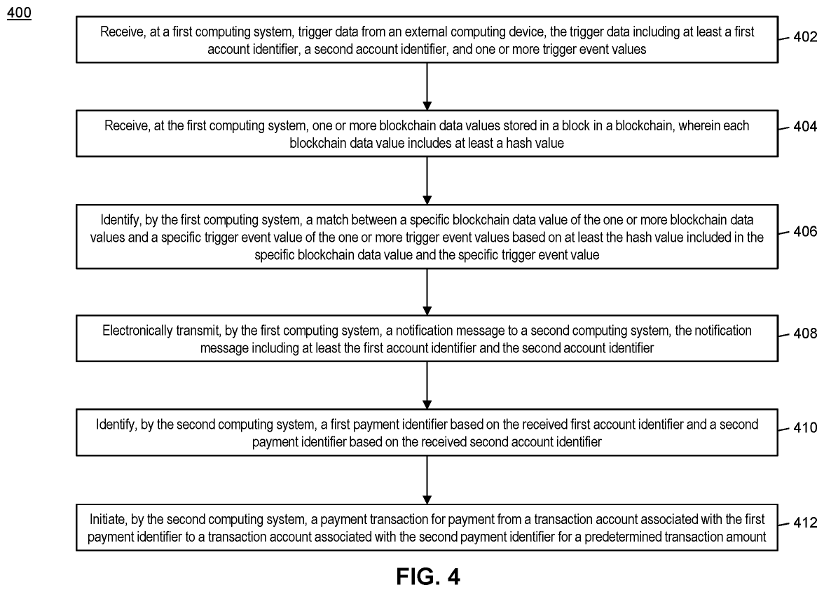

FIG. 4 illustrates a method 400 for triggering payment transactions through predetermined events identified using a blockchain.

In step 402, trigger data may be received (e.g., by a receiving device 202) at a first computing system (e.g., blockchain node 102) from an external computing device (e.g., buyer system 108, supplier system 110, etc.), the trigger data including at least a first account identifier, a second account identifier, and one or more trigger event values. In step 404, one or more blockchain data values stored in a block in a blockchain may be received (e.g., by a receiving device 202) at the first computing system, wherein each blockchain data value includes at least a hash value.

In step 406, a match between a specific blockchain data value of the one or more blockchain data values and a specific trigger event value of the one or more trigger event values may be identified (e.g., by a validation module 218) of the first computing system based on at least the hash value included in the specific blockchain data value and the specific trigger event value. In step 408, a notification message may be electronically transmitted (e.g., by a transmitting device 222) of the first computing system to a second computing system (e.g., payment provider 106), the notification message including at least the first account identifier and the second account identifier.

In step 410, a first payment identifier may be identified (e.g., by a querying module 214) by the second computing system based on the received first account identifier and a second payment identifier based on the received second account identifier. In step 412, a payment transaction may be initiated (e.g., by a transaction processing module 220) by the second computing system for payment from a transaction account associated with the first payment identifier to a transaction account associated with the second payment identifier for a predetermined transaction amount.

In one embodiment, the trigger data may include the predetermined transaction amount. In some embodiments, each of the one or more trigger event values included in the trigger data may be accompanied by an amount value, and the predetermined transaction amount may be the amount value accompanying the specific trigger event value. In one embodiment, the method 400 may further include receiving, by the second computing system, the first account identifier and the first payment identifier or the second account identifier and the second payment identifier from the external computing device.

In some embodiments, the notification message may further include an order number. In a further embodiment, the order number may be one of: a single order number included in the trigger data for each of the one or more trigger event values, or an order number associated with the specific trigger event value included in the trigger data. In one embodiment, initiating the payment transaction may include submitting a transaction message formatted pursuant to one or more standards to a financial institution using payment rails, wherein the transaction message includes a plurality of data elements including one or more data elements storing the first payment identifier, the second payment identifier, and the transaction amount. In a further embodiment, the one or more standards may include the ISO 8583 or ISO 20022 standards.

### Computer System Architecture

FIG. 5 illustrates a computer system 500 in which embodiments of the present disclosure, or portions thereof, may be implemented as computer-readable code. For example, the blockchain node 102 and payment provider 106 of FIG. 1 and the computing system 200 of FIG. 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for trigger payment transactions through predetermined events identified using a blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for triggering payment transactions through predetermined events identified using a blockchain, comprising:
receiving, at a first computing system, trigger data from an external computing device, the trigger data including at least a first account identifier, a second account identifier, and one or more trigger event values;
receiving, at the first computing system, one or more blockchain data values stored in a block in a blockchain, wherein each blockchain data value includes at least a hash value;
identifying, by the first computing system, a match between a specific blockchain data value of the one or more blockchain data values and a specific trigger event value of the one or more trigger event values based on at least the hash value included in the specific blockchain data value and the specific trigger event value;
electronically transmitting, by the first computing system, a notification message to a second computing system, the notification message including at least the first account identifier and the second account identifier;
identifying, by the second computing system, a first payment identifier based on the received first account identifier and a second payment identifier based on the received second account identifier; and
initiating, by the second computing system, a payment transaction for payment from a transaction account associated with the first payment identifier to a transaction account associated with the second payment identifier for a predetermined transaction amount.

2. The method of claim 1, wherein the trigger data includes the predetermined transaction amount.

3. The method of claim 1, wherein
each of the one or more trigger event values included in the trigger data is accompanied by an amount value, and
the predetermined transaction amount is the amount value accompanying the specific trigger event value.

4. The method of claim 1, further comprising:
receiving, by the second computing system, the first account identifier and the first payment identifier or the second account identifier and the second payment identifier from the external computing device.

5. The method of claim 1, wherein the notification message further includes an order number.

6. The method of claim 5, wherein the order number is one of: a single order number included in the trigger data for each of the one or more trigger event values, or an order number associated with the specific trigger event value included in the trigger data.

7. The method of claim 1, wherein initiating the payment transaction includes submitting a transaction message formatted pursuant to one or more standards to a financial institution using payment rails, wherein the transaction message includes a plurality of data elements including one or more data elements storing the first payment identifier, the second payment identifier, and the transaction amount.

8. The method of claim 7, wherein the one or more standards includes the ISO 8583 or ISO 20022 standards.

9. A system for triggering payment transactions through predetermined events identified using a blockchain, comprising:
a first computing system;
a second computing system; and
an external computing device, wherein
the first computing system
receives trigger data from the external computing device, the trigger data including at least a first account identifier, a second account identifier, and one or more trigger event values,
receives one or more blockchain data values stored in a block in a blockchain, wherein each blockchain data value includes at least a hash value,
identifies a match between a specific blockchain data value of the one or more blockchain data values and a specific trigger event value of the one or more trigger event values based on at least the hash value included in the specific blockchain data value and the specific trigger event value, and
electronically transmits a notification message to the second computing system, the notification message including at least the first account identifier and the second account identifier,
the second computing system
receives the notification message from the first computing system,
identifies a first payment identifier based on the received first account identifier and a second payment identifier based on the received second account identifier, and
initiates a payment transaction for payment from a transaction account associated with the first payment identifier to a transaction account associated with the second payment identifier for a predetermined transaction amount.

10. The system of claim 9, wherein the trigger data includes the predetermined transaction amount.

11. The system of claim 9, wherein
each of the one or more trigger event values included in the trigger data is accompanied by an amount value, and
the predetermined transaction amount is the amount value accompanying the specific trigger event value.

12. The system of claim 9, wherein the second computing system further receives the first account identifier and the first payment identifier or the second account identifier and the second payment identifier from the external computing device.

13. The system of claim 9, wherein the notification message further includes an order number.

14. The system of claim 13, wherein the order number is one of: a single order number included in the trigger data for each of the one or more trigger event values, or an order number associated with the specific trigger event value included in the trigger data.

15. The system of claim 9, further comprising:
a financial institution, wherein
initiating the payment transaction includes submitting a transaction message formatted pursuant to one or more standards to the financial institution using payment rails, wherein the transaction message includes a plurality of data elements including one or more data elements storing the first payment identifier, the second payment identifier, and the transaction amount.

16. The system of claim 15, wherein the one or more standards includes the ISO 8583 or ISO 20022 standards.
